(19) United States
(12) Patent Application Publication
(10) Pub. No.: US 2017/0068420 A1
(43) Pub. Date: Mar. 9, 2017

(54) METHOD FOR SMART ICON SELECTION OF GRAPHICAL USER INTERFACE

(71) Applicant: MITAC COMPUTING TECHNOLOGY CORPORATION, Hsinchu (TW)

(72) Inventors: Ching-Teng HSUEH, Hsinchu (TW); Hui-Chun YANG, Hsinchu (TW)

(73) Assignee: MITAC COMPUTING TECHNOLOGY CORPORATION, HSINCHU (TW)

(21) Appl. No.: 14/847,906

(22) Filed: Sep. 8, 2015

(51) Int. Cl. G06F 3/0481; G06F 3/0482; G06F 3/0484

(52) U.S. Cl. CPC G06F 3/04817; G06F 3/04842; G06F 3/04812; G06F 3/0482

(57) ABSTRACT

A method for smart icon selection of a graphical user interface which is adapted to an electronic device displaying a plurality of icons on a screen. Each of the icons is corresponding to an application program. The method includes: detecting a movement of a cursor when the location of the cursor is not located over any of the icons; selecting an icon among the icons based on an algorithm; and generating a noticeable indicator to the selected icon. The algorithm is in accordance with parameters of the execution times of each of the application programs respectively corresponding to each of the icons, the distance between the locations of the cursor and each of the icons, the moving tendency of the cursor, and an icon corresponding to an application program being preset by a user.

### BACKGROUND

Technical Field

The instant disclosure relates to a graphical user interface, and more particularly, to a method for smart icon selection of a graphical user interface.

Related Art

With the increasing popularity and the public preference of the smart phones and the tablet computers, nowadays software engineers manage to improve user experiences in light of operation methods as to electronic devices. Most of these improvements of the operation methods focus on small size portable electronic devices. The so-called small size electronic devices are referred to smart phones or tablet computers with screens having visual sizes equal to or less than 10 inches in general. With regard to electronic devices with large sizes (larger than those small size electronic devices), improvements of operation methods of these large size electronic devices are also needed but have not been provided yet.

For example, the sizes and resolutions of screens of personal computers tend to be larger and higher. Users of personal computers usually use screens with size of 24 inches or larger. More and more people even use screens with size of 27 inches. The larger the size of the screen is, the more the documents can be displayed on the screen at the same time. When a screen has large size and high resolution, the distance between icons and a cursor displayed on the screen may be too long to cause inconvenience in operation. Under the circumstance that an icon is far away from the cursor, the user has to move a mouse in a longer distance to have the cursor eventually located over the icon so as to be able to select the icon for executing a specific application program. The inevitable long movement in operation is inconvenient.

In addition, if users are going to frequently execute a certain application program (e.g., a software of a game) in a certain period, they are required each time they want to execute the application program to repetitively move a cursor over the location at which a corresponding icon is located so as to click the icon based on the conventional graphical user interface. The conventional graphical user interface cannot be utilized for predicting which one of the icons is wanted by the user to click in time in a manner of analyzing the habit of the user regarding the operation.

There exists no any operation method that allows users to accurately select an icon without user's moving the cursor over the icon.

### SUMMARY

To address the above issue, the instant disclosure provides a method for smart icon selection of a graphical user interface which is adapted to an electronic device displaying a plurality of icons on a screen. Each of the icons is corresponding to an application program, and the application program is executed when a corresponding icon is clicked and selected. The method for smart icon selection of the graphical user interface comprises: detecting a movement of a cursor when the location of the cursor is not located over any of the icons; selecting an icon among the icons based on an algorithm; and generating a noticeable indicator to the selected icon. In the step of selecting an icon among the icons based on the algorithm, the selection among the icons displayed on the screen is in accordance with at least one parameter of the execution times of each of the application programs respectively corresponding to each of the icons, the distance between the locations of the cursor and each of the icons, the moving tendency of the cursor, and an icon corresponding to an application program being preset by a user.

According to an embodiment of the instant disclosure, the step of generating the noticeable indicator comprises generating a trail. One end of the trail is connected to the cursor, and the other end of the trail is connected to the selected icon.

According to an embodiment of the instant disclosure, the step of generating the noticeable indicator comprises having the background color of the selected icon changed to be distinguished from those of the unselected icons.

According to an embodiment of the instant disclosure, the step of generating the noticeable indicator comprises having the selected icon blinked.

According to an embodiment of the instant disclosure, the step of generating the noticeable indicator comprises having the brightness of the unselected icons to be lower than that of the selected icon.

According to an embodiment of the instant disclosure, the step of generating the noticeable indicator comprises having the selected icon enlarged.

According to an embodiment of the instant disclosure, the method for smart icon selection of the graphical user interface further comprises: detecting a clicking signal after generating the noticeable indicator to the selected icon, and executing the application program corresponding to the selected icon according to the clicking signal.

According to an embodiment of the instant disclosure, the algorithm is based on the execution times of each of the application programs respectively corresponding to each of the icons, and an application program with the most execution times is selected.

According to an embodiment of the instant disclosure, the algorithm is based on the distance between the locations of the cursor and each of the icons, and an icon being nearest to the location of the cursor is selected.

According to an embodiment of the instant disclosure, the algorithm is based on the moving tendency of the cursor, and an icon being nearest to the cursor along a straight direction pointed by a vector defined by an initial and a terminal coordinates of the movement of the cursor is selected.

According to an embodiment of the instant disclosure, the method for smart icon selection of the graphical user interface further comprises: dividing the screen into a plurality of displaying areas; and detecting which one of the displaying areas has the cursor located therein. The selection among the icons based on the algorithm is in accordance with at least one parameter of the execution times of each of the application programs respectively corresponding to each of the icons in the displaying area at which the cursor is located, the distance between the locations of the cursor and each of the icons in the displaying area at which the cursor is located, and the moving tendency of the cursor in the displaying area.

The features of the instant disclosure will no doubt become understandable to those of ordinary skill in the art after reading the following detailed description of the preferred embodiment that is illustrated in the various figures and drawings.

### BRIEF DESCRIPTION OF THE DRAWINGS

FIG. 1 illustrates a flow chart of a method according to a first embodiment of the instant disclosure;

FIG. 2 illustrates a first state diagram according to an embodiment of the instant disclosure;

FIG. 3 illustrates a flow chart of a method according to a second embodiment of the instant disclosure;

FIG. 4 illustrates a second state diagram according to an embodiment of the instant disclosure;

FIG. 5 illustrates a third state diagram according to an embodiment of the instant disclosure; and

FIG. 6 illustrates a fourth state diagram according to an embodiment of the instant disclosure.

### DETAILED DESCRIPTION

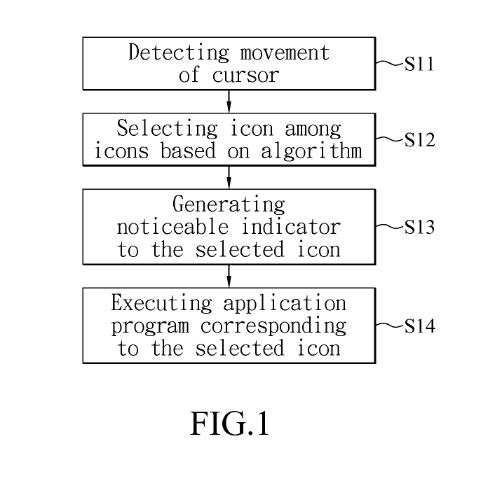

Referring to FIG. 1, FIG. 1 is a flow chart of a method according to a first embodiment of the instant disclosure. The embodiment is adapted to an electronic device. The electronic device includes a graphical user interface by which a user can perform operation. The graphical user interface can display a plurality of icons on a screen of the electronic device. Each of the icons is corresponding to a distinct application program. The screen has large size and high resolution. For example, the size is at least 24 inches, and the resolution abides by the Full HD standard. The screen can also be the monitor of the central console of a vehicle. The size of the screen of the central console is usually not larger than 8 inches. The operation of movements of a cursor on the screen is performed via a touch pad near a seat armrest by a user. The method of the instant disclosure can be adapted to different types of electronic devices having different sizes of screens. The effect of the method of the instant disclosure is to reduce the time spent on the operation process. When the method of the instant disclosure is adapted to the two types of the aforementioned screen, the effect is significant.

The steps of the embodiment are described below. It shall be understood that the sequence of the described steps can be various according to different situation and is not necessarily an executing sequence practiced on an electronic device.

Step S11 is: detecting a movement of a cursor.

The step is to determine whether the cursor is moved by the user's operation. With regard to a kind of a graphical user interface adapted to a small size screen, the cursor is usually not displayed on the screen since the user can easily perform operation as to selecting any of icons distributed all over the screen by one hand at short range. The kind of the small size screen is not the subject to which the embodiment is adapted. The subject that the embodiment intends to improve is a graphical user interface by which users can perform the operation in a manner of moving the cursor to select icons displayed on the screen which has large size and high resolution or is the monitor of the central console of a vehicle.

In addition to using conventional mouse, keyboards, and touch pads, the method of controlling the movement of the cursor can be performed by using trackballs, TV dongles (smart dongles), sticks, air mouse, gesture mouse, or gesture control.

Step S12 is: selecting an icon among the icons based on an algorithm.

The step is to select an icon among the icons displayed on the screen based on an algorithm. The algorithm is in accordance with parameters described in paragraphs below. When the cursor is moved but not located over any of the icons yet, the analysis with regard to determining which one of the icons is wanted by the user to select is performed.

One of the parameters that the algorithm is in accordance with is the execution times of each of the application programs respectively corresponding to each of the icons during a period of time in the past. The period of time may be, for example, during last month or the time period counted from the first time the user executed the application program. An icon of an application program with the most execution times can be considered as the one the user most likely wants to select.

Another one of the parameters that the algorithm is in accordance with is the distance between the locations of the cursor and each of the icons. An icon nearest to the location of the cursor can be considered as the one the user most likely wants to select. In other words, the algorithm determines which one of the icons is nearest to the current location of the cursor by calculating the distance between the locations of the cursor and each of the icons during the movement of the cursor. The icon nearest to the current location of the cursor is considered as the one the user most likely wants to select.

Another one of the parameters that the algorithm is in accordance with is the moving tendency of the cursor. In other words, a vector of a displacement of the cursor is calculated and defined by the change of the locations of the cursor. An icon pointed by the vector of the displacement of the cursor is considered as the one the user most likely wants to select.

Another one of the parameters that the algorithm is in accordance with is based on a user's preset. For example, an icon which is directly preset by the user is directly selected based on the algorithm when the cursor is moved. For example, when the user starts the vehicle, turns on the monitor of the central console, and moves the cursor by the touch pad near the seat armrest, the icon corresponding to the application program of the user's preset, such as a program for navigation or music-playing, is directly selected based on the algorithm. The power source of the electronic device can be a car charger of the vehicle, and the car charger is capable of providing power with the premise that the vehicle is started; therefore, the electronic device can detect that the vehicle is started once the electronic device is powered.

Step S13 is: generating a noticeable indicator to the selected icon.

The step is to emphasize the selected icon on the screen so that the user can realize which one of the icons is selected at a glance, and, immediately, the user can confirm whether the selected icon is the one the user most likely wants to select.

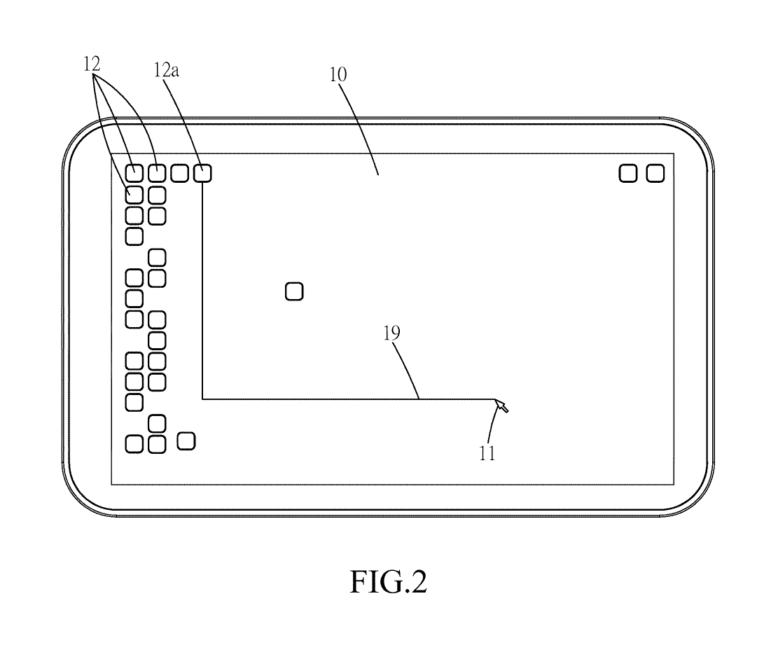

As shown in FIG. 2, a method of generating the noticeable indicator can be generating a trail 19 on the screen 10. One end of the trail 19 is connected to the cursor 11, and the other end of the trail 19 is connected to the selected icon 12a. The other icons 12 are remain in the same condition. As a result, the user can easily find out the icon 12a selected based on the algorithm, and the user can further decide whether to execute the application program corresponding to the icon 12a selected based on the algorithm or not.

Another method of generating the noticeable indicator is to have the background color of the icon 12a selected based on the algorithm changed to be distinguished from those of the unselected icons 12. As a result, the user can easily find out the icon 12a selected based on the algorithm, and the user can further decide whether to execute the application program corresponding to the icon 12a selected based on the algorithm or not.

Another method of generating the noticeable indicator is to have the icon 12a selected based on the algorithm blinked. In the same way, the user can easily find out the icon 12a selected based on the algorithm, and the user can further decide whether to execute the application program corresponding to the icon 12a selected based on the algorithm or not.

Another method of generating the noticeable indicator is to have the brightness of the unselected icons 12 to be lower, and to have the brightness of the selected icon 12a remained the same or to be higher. Namely, the brightness of the unselected icons 12 is lower than that of the selected icon 12a. As a result, the user can easily find out the icon 12a selected based on the algorithm, and the user can further decide whether to execute the application program corresponding to the icon 12a selected based on the algorithm or not.

In addition, another method of generating the noticeable indicator is to have the icon 12a selected based on the algorithm enlarged. In the same way, the user can easily find out the icon 12a selected based on the algorithm at a glance, and the user can further decide whether to execute the application program corresponding to the icon 12a selected based on the algorithm or not.

Step S14 is: executing an application program corresponding to the selected icon.

The aforementioned steps S11-S13 illustrate the embodiments regarding determining which one of the icons is wanted by the user to select in advance, before the user moves the cursor over the icon. When the step of determining which one of the icons is wanted by the user to select is done, the next step is with regard to methods of allowing the user to conveniently execute the application program corresponding to the selected icon.

After the icon is selected and the noticeable indicator is generated, the current location of the cursor is not located over the icon that the user wants to select. Therefore, an application program corresponding to the icon needs to be executed in a manner different from the conventional way of clicking on the icon.

One of the methods of executing the application program corresponding to the selected icon is to detect whether a clicking signal is generated after generating the noticeable indicator to the selected icon. The source of the clicking signal can be the mouse or the touch pad. For example, the clicking signal can be generated via clicking the left button of the mouse or clicking the touch pad by the user.

Another one of the methods of executing the application program corresponding to the selected icon 12a is to detect whether the location of the cursor 11 is changed after generating the noticeable indicator to the selected icon 12a. If the location of the cursor 11 remains still for a predetermined period, the application program corresponding to the selected icon 12a is executed. The value of the predetermined period can be defined by the user or can be a system default value. In other words, if the user confirm that the selection of the icon 12a selected based on the algorithm is correct during the movement of the cursor 11, the user can stop the movement of the cursor 11, and after the predetermined period is over, the application program corresponding to the selected icon 12a is executed. However, even the user moves the cursor and then stops moving the cursor, it doesn't mean that the user really wants to execute the application program corresponding to the icon 12a selected based on the algorithm. It may be the situation that the user just doesn't want to use the electronic device, or it may be the situation that the user has to stop using the electronic device due to some incidents. Therefore, the aforementioned method for executing the application program can be switched via software or hardware. Namely, the aforementioned method for executing the application program can be activated or deactivated according to the user's demand. The misjudgment that the electronic device executes an application program due to the situation that the user just doesn't want to use the electronic device can be avoidable.

In addition, the two aforementioned methods for executing the application program can be integrated. In other words, the application program corresponding to the selected icon is executed immediately when the clicking signal is detected; alternatively, the application program corresponding to the selected icon is executed when the clicking signal is not detected but the cursor remains still for a predetermined period after the cursor's last movement.

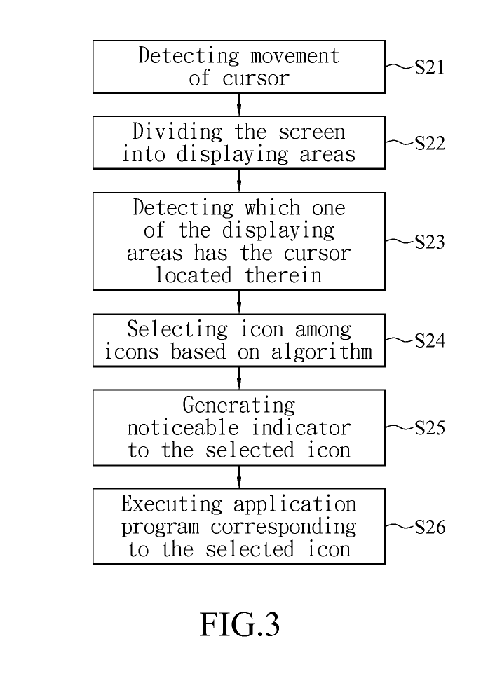

Referring to FIG. 3, FIG. 3 is a flow chart of a method according to a second embodiment of the instant disclosure. The embodiment is adapted to an electronic device. The electronic device includes a graphical user interface by which a user can perform operation. The graphical user interface can display a plurality of icons on a screen of the electronic device. Each of the icons is corresponding to a distinct application program. The screen has large size and high resolution. For example, the size is at least 24 inches, and the resolution abides by the Full HD standard. Under the circumstance that the screen has higher resolution, such as a screen with 2K or 4K panel, the effect that the embodiment provides is significant. The screen can also be the monitor of the central console of a vehicle. The size of the screen of the central console is usually not larger than 8 inches. The operation of movements of a cursor on the screen is performed by a touch pad near a seat armrest. The embodiment can be adapted to different types of electronic devices having different sizes of screens. The effect of the embodiment is to reduce the time spent on the operation process. When the method of the instant disclosure is adapted to the two types of the aforementioned screen, the effect is significant.

The steps of the embodiment are described below. It shall be understood that the sequence of the described steps can be various according to different situation and is not necessarily an executing sequence practiced on an electronic device.

Step S21 is: detecting a movement of a cursor.

The step the same as the step S11 is to determine whether the cursor is moved by the user's operation. With regard to a kind of a graphical user interface adapted to a small size screen, the cursor is usually not displayed on the screen since the user can easily perform operation as to selecting any of icons distributed all over the screen by one hand at short range. The kind of the small size screen is not the subject to which the embodiment is adapted. The subject that the embodiment intends to improve is a graphical user interface by which users can perform the operation in a manner of moving the cursor to select icons displayed on the screen which has large size and high resolution or is the monitor of the central console of a vehicle.

Step S22 is: dividing the screen into a plurality of displaying areas.

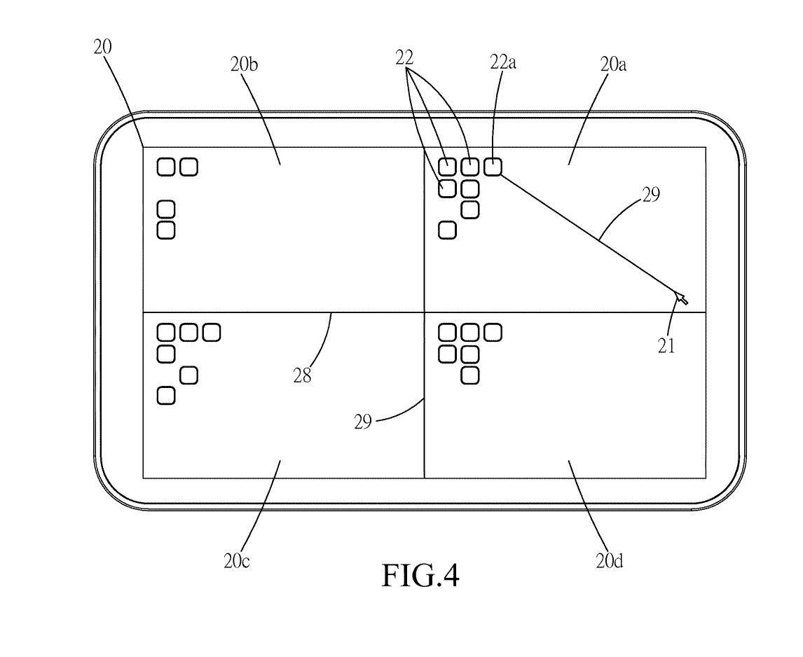

As shown in FIG. 4, the step is to divide the screen 20 into four displaying areas 20a, 20b, 20c, and 20d. For example, the screen 20 is divided into four quadrants based on the Cartesian coordinate system. Each of the quadrants respectively corresponds to a displaying area. The distinction of the four displaying areas can be performed by programs. The X-axis 28 and the Y-axis 29 are not necessarily displayed on the screen 20 and are invisible. But the X-axis 28 and the Y-axis 29 can also be displayed on the screen 20 and are visible.

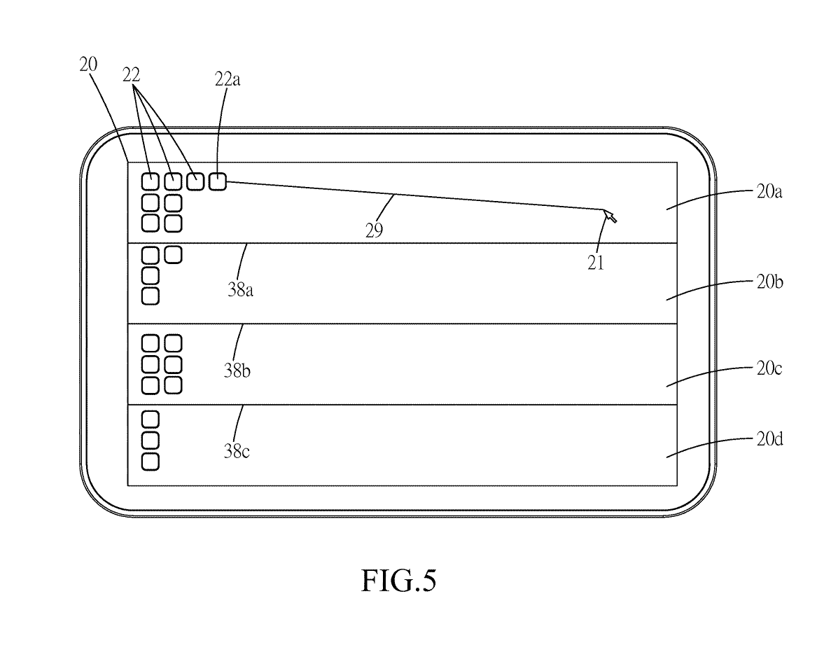

As shown in FIG. 5, the four displaying areas 20a, 20b, 20c, and 20d can be arranged from the top side to the bottom side. The X-axes 38a, 38b, and 38c dividing the four displaying areas 20a, 20b, 20c, and 20d can be performed by programs and are invisible. But the X-axes 38a, 38b, and 38c can also be visible lines.

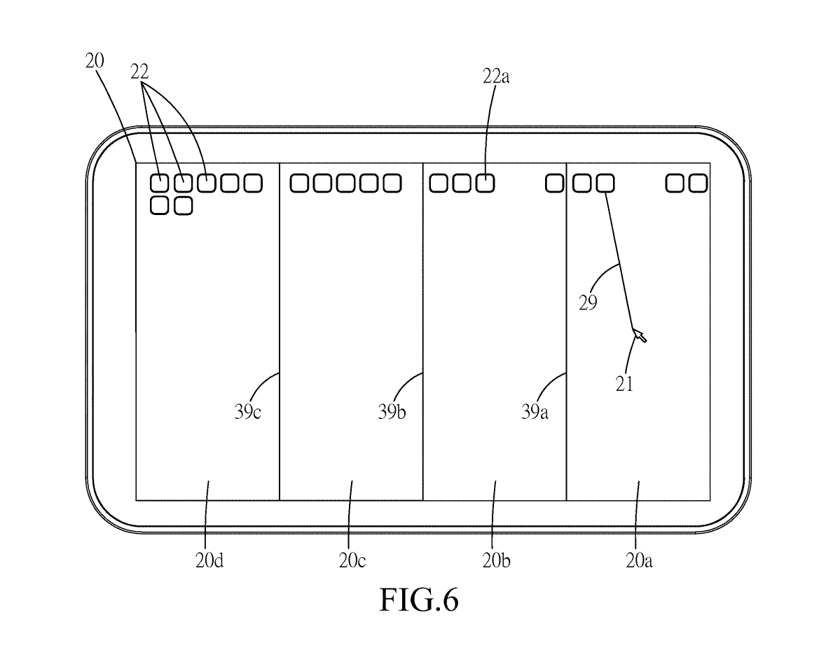

As shown in FIG. 6, the four displaying areas 20a, 20b, 20c, and 20d can be arranged from the left side to the right side or from the right side to the left side. The Y-axes 39a, 39b, and 39c dividing the four displaying areas 20a, 20b, 20c, and 20d can be performed by program and are invisible. But the Y-axes 39a, 39b, and 39c can also be visible lines.

In addition, the areas of each of the displaying areas are not necessarily equivalent. The user can adjust the size of the areas of each of the displaying areas based on the distribution of the icons 22 on the screen 20 or based on the user's habit.

In the embodiment, the areas of each of the displaying areas are equivalent. As shown in FIG. 4, for example, an initial location of the cursor 21 is located at the displaying area 20a.

Step S23 is: detecting which one of the displaying areas has the cursor located therein.

The step is to detect which one of the displaying areas has the cursor 21 located therein. As shown in FIG. 4, FIG. 5, and FIG. 6, the cursor 21 is located at the displaying area 20a.

Step S24 is: selecting an icon among the icons based on an algorithm.

The step S24, which is different from the step S12 of the first embodiment, is to select an icon among the icons in the displaying area 20a at which the cursor 21 is located based on an algorithm. The icons in the displaying area 20b, 20c, and 20d at which the cursor 21 is not located are directly excluded based on the algorithm. The algorithm is in accordance with parameters described below. When the cursor 21 is moved but not located over any of the icons in the displaying area 20a yet, the analysis with regard to determining which one of the icons is wanted by the user to select is performed.

One of the parameters that the algorithm is in accordance with is the execution times of each of the application programs respectively corresponding to each of the icons during a period of time in the past. The period of time may be, for example, during last month or the time period counted from the first time the user executed the application program. An icon of an application program with the most execution times can be considered as the one the user most likely wants to select.

Another one of the parameters that the algorithm is in accordance with is the distance between the locations of the cursor and each of the icons. An icon nearest to the location of the cursor can be considered as the one the user most likely wants to select. In other words, the algorithm determines which one of the icons is nearest to current location of the cursor by continuously calculating the distance between the locations of the cursor and each of the icons during the movement of the cursor. The icon nearest to the current location of the cursor is considered as the one the user most likely wants to select.

Another one of the parameters that the algorithm is in accordance with is the moving tendency of the cursor. In other words, a vector of a displacement of the cursor is calculated and defined by the change of the locations of the cursor. An icon pointed by the vector of the displacement of the cursor is considered as the one the user most likely wants to select.

Another one of the parameters that the algorithm is in accordance with is based on a user's preset. For example, the user can define that an application program is preset to be executed when the cursor is located at a certain displaying area. Different application programs can be preset to be executed when the cursor is located at different displaying areas. The premise is that the icons corresponding to the application programs are respectively located at each of the displaying areas. As a result, an icon corresponding to a preset application program is directly selected based on the algorithm when the cursor is moved in a certain displaying area. For example, when the user starts the vehicle, turns on the monitor of the central console, and moves the cursor by the touch pad near the seat armrest, the icon corresponding to the application program of the user's preset, such as a program for navigation or music-playing, is directly selected based on the algorithm.

Step S25 is: generating a noticeable indicator to the selected icon.

The step is to emphasize the selected icon on the screen so that the user can realize which one of the icons is selected at a glance, and, immediately, the user can confirm whether the selected icon is the one the user most likely wants to select.

As shown in FIG. 4 to FIG. 6, a method of generating the noticeable indicator can be generating a trail 29 in the displaying area 20a on the screen 20. One end of the trail 29 is connected to the cursor 21, and the other end of the trail 29 is connected to the selected icon 22a. The other icons 22 in the displaying area 20a are remain in the same condition. As a result, the user can easily find out the icon 22a selected based on the algorithm, and the user can further decide whether to execute the application program corresponding to the icon 22a selected based on the algorithm or not.

Another method of generating the noticeable indicator is to have the background color of the icon 22a selected based on the algorithm changed to be distinguished from those of the unselected icons 22 in the display area 20a. As a result, the user can easily find out the icon 22a selected based on the algorithm, and the user can further decide whether to execute the application program corresponding to the icon 22a selected based on the algorithm or not.

Another method of generating the noticeable indicator is to have the icon 22a selected based on the algorithm blinked. In the same way, the user can easily find out the icon 22a selected based on the algorithm, and the user can further decide whether to execute the application program corresponding to the icon 22a selected based on the algorithm or not.

Another method of generating the noticeable indicator is to have the brightness of the unselected icons 22 in the displaying area 20a to be lower, and to have the brightness of the selected icon 22a remained the same or to be higher. Namely, the brightness of the unselected icons 22 in the displaying area 20a is lower than that of the selected icon 22a. As a result, the user can easily find out the icon 22a selected based on the algorithm, and the user can further decide whether to execute the application program corresponding to the icon 22a selected based on the algorithm or not.

In addition, another method of generating the noticeable indicator is to have the icon 22a selected based on the algorithm enlarged. In the same way, the user can easily find out the icon 22a selected based on the algorithm at a glance, and the user can further decide whether to execute the application program corresponding to the icon 22a selected based on the algorithm or not.

Step S26 is: executing an application program corresponding to the selected icon.

After the icon is selected and the noticeable indicator is generated, the current location of the cursor 21 is not located over the icon 22a that the user wants to select. Therefore, an application program corresponding to the icon needs to be executed in a manner different from the conventional way of clicking on the icon.

One of the methods of executing the application program corresponding to the selected icon 22a is to detect whether a clicking signal is generated after generating the noticeable indicator to the selected icon 22a. The source of the clicking signal can be the mouse or the touch pad. For example, the clicking signal can be generated via clicking the left button of the mouse or clicking the touch pad by the user.

Another one of the methods of executing the application program corresponding to the selected icon 22a is to detect whether the location of the cursor 21 is changed after generating the noticeable indicator to the selected icon 22a. If the location of the cursor 21 remains still for a predetermined period, the application program corresponding to the selected icon 22a is executed. The value of the predetermined period can be defined by the user or can be a system default value. In other words, if the user confirm that the selection of the icon 22a selected based on the algorithm is correct during the movement of the cursor 21, the user can stop the movement of the cursor 21, and after the predetermined period is over, the application program corresponding to the selected icon 12a is executed. However, even the user moves the cursor and then stops moving the cursor, it doesn't mean that the user really wants to execute the application program corresponding to the icon 12a selected based on the algorithm. It may be the situation that the user just doesn't want to use the electronic device, or it may be the situation that the user has to stop using the electronic device due to some incidents. Therefore, the aforementioned method for executing the application program can be switched via software or hardware. Namely, the aforementioned method for executing the application program can be activated or deactivated according to the user's demand. The misjudgment that the electronic device executes an application program due to the situation that the user just doesn't want to use the electronic device can be avoidable.

In addition, the two aforementioned methods for executing the application program can be integrated. In other words, the application program corresponding to the selected icon 22a is executed immediately when the clicking signal is detected; alternatively, the application program corresponding to the selected icon 22a is still executed when the clicking signal is not detected but the cursor remains still for a predetermined period after the cursor's last movement.

The method for smart icon selection of the graphical user interface disclosed by the aforementioned embodiments is capable of determining which one of the icons may be wanted by the user to select based on the algorithm and generating the noticeable indicator to the icon in advance without the user's moving the cursor over the icon the user wants to select. Based on the embodiments, the user can quickly executes an application program the user wants to execute without spending time on moving the cursor over the icon.

While the instant disclosure has been described by way of example and in terms of the preferred embodiments, it is to be understood that the instant disclosure needs not be limited to the disclosed embodiments. For anyone skilled in the art, various modifications and improvements within the spirit of the instant disclosure are covered under the scope of the instant disclosure. The covered scope of the instant disclosure is based on the appended claims.

What is claimed is:

1. A method for smart icon selection of a graphical user interface, adapted to an electronic device displaying a plurality of icons on a screen, wherein each of the icons is corresponding to an application program, the method comprising:
detecting a movement of a cursor when the location of the cursor is not located over any of the icons;
selecting an icon among the icons based on an algorithm; and
generating a noticeable indicator to the selected icon;
wherein the selection among the icons based on the algorithm is in accordance with at least one parameter of the execution times of each of the application programs respectively corresponding to each of the icons, the distance between the locations of the cursor and each of the icons, the moving tendency of the cursor, and an icon corresponding to an application program being preset.

2. The method for smart icon selection of a graphical user interface of claim 1, wherein generating the noticeable indicator comprises generating a trail, one end of the trail is connected to the cursor, and the other end of the trail is connected to the selected icon.

3. The method for smart icon selection of a graphical user interface of claim 1, wherein generating the noticeable indicator comprises: having the background color of the selected icon changed to be distinguished from those of the unselected icons, having the selected icon blinked, having the selected icon enlarged, or having the brightness of the unselected icons to be lower than that of the selected icon.

4. The method for smart icon selection of a graphical user interface of claim 1, further comprising:
detecting a clicking signal after generating the noticeable indicator to the selected icon; and
executing the application program corresponding to the selected icon according to the clicking signal.

5. The method for smart icon selection of a graphical user interface of claim 1, further comprising:
detecting whether the location of the cursor is changed after generating the noticeable indicator to the selected icon; and
executing the application program corresponding to the selected icon if the location of the cursor remains still for a predetermined period.

6. The method for smart icon selection of a graphical user interface of claim 1, wherein the algorithm is based on the execution times of each of the application programs respectively corresponding to each of the icons, and an application program with the most execution times is selected.

7. The method for smart icon selection of a graphical user interface of claim 1, wherein the algorithm is based on the distance between the locations of the cursor and each of the icons, and an icon being nearest to the location of the cursor is selected.

8. The method for smart icon selection of a graphical user interface of claim 1, wherein the algorithm is based on the moving tendency of the cursor, and an icon being nearest to the cursor along a straight direction pointed by a vector defined by an initial and a terminal coordinates of the movement of the cursor is selected.

9. The method for smart icon selection of a graphical user interface of claim 1, wherein the electronic device is disposed in a vehicle, the method further comprises:
detecting whether the vehicle is started; and
directly selecting the icon corresponding to the application program being preset if the vehicle is started and the movement of the cursor is detected.

10. The method for smart icon selection of a graphical user interface of claim 1, further comprising:
dividing the screen into a plurality of displaying areas; and
detecting which one of the displaying areas has the cursor located therein;
wherein the selection among the icons based on the algorithm is in accordance with at least one parameter of the execution times of each of the application programs respectively corresponding to each of the icons in the displaying area at which the cursor is located, the distance between the locations of the cursor and each of the icons in the displaying area at which the cursor is located, the moving tendency of the cursor in the displaying area, and the icon corresponding to the application program being preset in the displaying area at which the cursor is located.

11. The method for smart icon selection of a graphical user interface of claim 10, wherein generating the noticeable indicator comprises generating a trail, one end of the trail is connected to the cursor, and the other end of the trail is connected to the selected icon.

12. The method for smart icon selection of a graphical user interface of claim 10, wherein generating the noticeable indicator comprises: having the background color of the selected icon changed to be distinguished from those of the unselected icons, having the selected icon blinked, having the selected icon enlarged, or having the brightness of the unselected icons to be lower than that of the selected icon.

13. The method for smart icon selection of a graphical user interface of claim 10, further comprising:
detecting a clicking signal after generating the noticeable indicator to the selected icon; and
executing the application program corresponding to the selected icon according to the clicking signal.

14. The method for smart icon selection of a graphical user interface of claim 10, further comprising:
detecting whether the location of the cursor is changed after generating the noticeable indicator to the selected icon; and
executing the application program corresponding to the selected icon if the location of the cursor remains still for a predetermined period.

15. The method for smart icon selection of a graphical user interface of claim 10, wherein the algorithm is based on the execution times of each of the application programs respectively corresponding to each of the icons in the displaying area at which the cursor is located, and an application program with the most execution times is selected.

16. The method for smart icon selection of a graphical user interface of claim 10, wherein the algorithm is based on the distance between the locations of the cursor and each of the icons in the displaying area at which the cursor is located, and an icon being nearest to the location of the cursor is selected.

17. The method for smart icon selection of a graphical user interface of claim 10, wherein the algorithm is based on the moving tendency of the cursor in the displaying area, and an icon being nearest to the cursor along a straight direction pointed by a vector defined by an initial and a terminal coordinates of the movement of the cursor is selected.

18. The method for smart icon selection of a graphical user interface of claim 10, wherein the electronic device is disposed in a vehicle, the method comprises:
detecting whether the vehicle is started; and
directly selecting the icon corresponding to the application program being preset if the vehicle is started and the movement of the cursor is detected.

19. The method for smart icon selection of a graphical user interface of claim 10, wherein dividing the screen into the plurality of displaying areas comprises dividing the screen into four displaying areas parallel to each other.

20. The method for smart icon selection of a graphical user interface of claim 10, wherein dividing the screen into the plurality of displaying areas comprises dividing the screen into four displaying areas respectively located at four quadrants.
